(19) United States
(12) Patent Application Publication
(10) Pub. No.: US 2008/0134253 A1
(43) Pub. Date: Jun. 5, 2008

(54) Data upload and broadcast system

(76) Inventor: Grant Romain, Hertfordshire (GB)

Correspondence Address: CHRISTIE, PARKER & HALE, LLP, PO BOX 7068, PASADENA, CA, 91109-7068, US

(21) Appl. No.: 11/634,333

(22) Filed: Dec. 4, 2006

(51) Int. Cl. H04N 5/445

(52) U.S. Cl. 725/61

(57) ABSTRACT

A TV content transmission and broadcasting system comprising means for transmitting video content to a server; means for reviewing the content; means for allocating a unique identifier to the content; means for broadcasting the content via a TV channel; and means enabling votes to be cast for that content whereby subsequent transmission of the content is determined by rules associated with votes cast.

This invention relates to a data upload and broadcast system.

In particular, it relates to a system enabling users to transmit their own audiovisual content to a service provider and for broadcasting the content over a television channel.

Traditionally, content for broadcast via transmission via television channels was generated professionally, either by the channels themselves or by independent companies who then submitted work to the channels. A high degree of editorial control has always been placed upon the nature and type of work broadcast.

The present invention arose in an attempt to provide a method and apparatus for allowing ‘amateur’ content generated by a user over low cost domestic video equipment or portable equipment such as mobile telephones to transmit video data for broadcast via a TV transmission.

According to the present invention in a first aspect there is provided a TV content transmission and broadcasting system comprising means for transmitting video content to a server; means for reviewing the content; means for allocating a unique identifier to the content; means for broadcasting the content via a TV channel; and means enabling votes to be cast for that content whereby subsequent transmission of the content is determined by rules associated with votes cast.

Preferably, the means for enabling submission of content includes a charging mechanism and the means for enabling voting also includes a charging mechanism.

Embodiments of the invention will now be described, by way of example only, with reference to the accompanying schematic drawings in which:

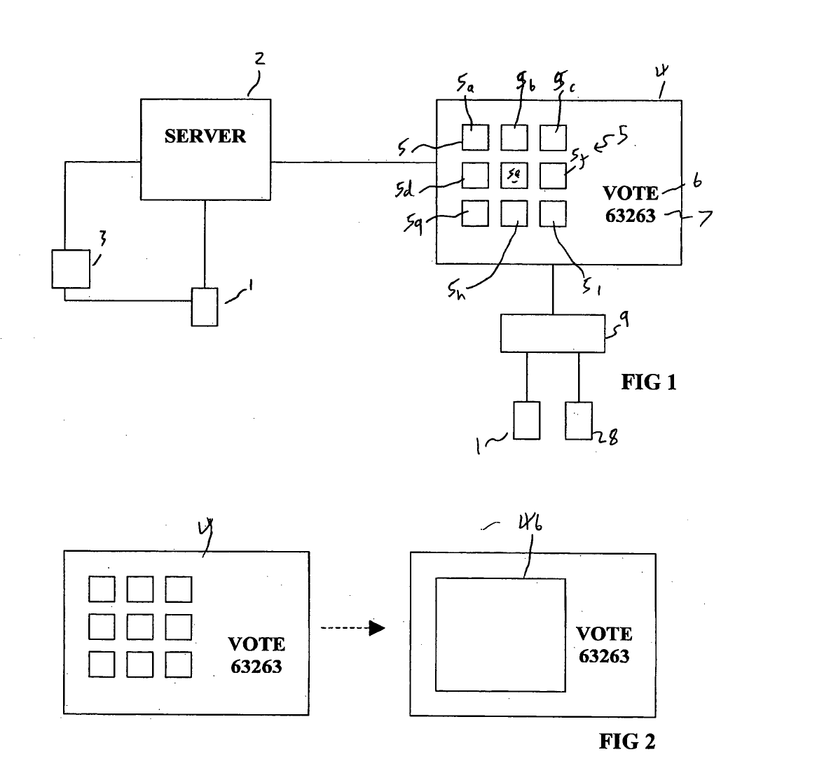

FIG. 1 shows schematic a system for uploading video content and transmitting it; and

FIG. 2 shows TV displays.

In embodiments of the invention, content is uploaded by viewer of TV channel and if then, after a moderation process, displayed on the channel in the manner shown in more detail below.

The process can be divided into four stages. There is a first submission stage, a second moderation stage, a third notification stage and a fourth broadcast stage.

### Stage 1 Submission

Content may be submitted in a large number of ways. In each of these, the content is generated and then sent by a transmitting element 1 to a server 2. The transmitting element 1 may be a mobile phone or other device with a telecommunications facility. Content may be submitted to the server using multi-media services (MMS). The content may be generated at the mobile itself using a built video camera or may be generated externally, by an external video camera for example, and then loaded onto the mobile phone for subsequent transmission to the server. Typical content may be a video clip of low to medium resolution and of perhaps 10 seconds duration, although subject to bandwidth and memory capacity the clip may be of longer or shorter duration than this and may be of relatively high resolution. Typical resolutions may be 320×240 pixels, or lower but perhaps resolutions of 640×480 pixels or greater may be transmitted. The operators of the server may specify that the video clip is to be sent in a particular format such as WMA, AVI, MPEG and so on.

Other variations include submitting content using an upload mechanism via a web page on the internet, either from a mobile device 1 or from another computer, or submitting content via email (i.e. as an email attachment) or simply by sending content on a suitable data carrier such as an optical disc by post or hand delivery. Content may also be submitted using a telecommunications based video recording service such as a so-called 3G (third generation or UMTS) service. This can be done by making two-way video calls using third generation mobile telephone networks. For example, a user of a 3G enabled mobile telephone 1 may make a video call to the server or operator 2. As part of the process they can be asked to record the call, via a menu. Then video recorded by the camera 3 forming part of the mobile phone 1 is sent directly (in real time) over the video call link to the server 2 and then recorded directly onto the system.

It should be noted that although the content is described most commonly in this specification as being video content, it may alternatively be still images, videos, music or other sound files or recordings, static photographic images (such as JPEGs, BMPs and so on) or other content.

### Stage 2 Moderation

All content delivered to the server most preferably goes through a moderation stage and this will generally be done by a human who views the content and checks that it conforms with local broadcast standards relevant to the country in which the content is to be broadcast. The moderator may also be able to mark the content with a rating according to the level of various parameters, such as violence, nudity and sexual content and so on. He may also mark it according to whether the content is suitable for being transmitted pre- or after a predetermined watershed time, e.g. 9.00 p.m.

### Stage 3 Notification

After moderation, and provided the content is suitable for transmission, the submitting party is notified by a notifying module 3 by a suitable mechanism, such as SMS text messaging, that their submission was successful and with a unique reference number or PIN. This reference number is associated with the content and is displayed on screen whenever the content is played.

If the content fails the moderation step, then the submitting party is also notified via the notifying module 3 via SMS that the content failed moderation and is asked to resubmit in accordance with published terms and conditions. The moderation module 3 may be associated with, or form part of, a charging module which, in sending SMS messages to the user 1, instigates a charging process. SMS charging processes and schemes are well known.

### Stage 4 Broadcast

Once an item of content such as a video clip has passed stages 1 to 3, it is then ready for broadcast. Depending on the time of day and the nature of the content, it is placed into one of two libraries, pre-watershed and post-watershed. Pre-watershed clips can be broadcast at any time of the day and post-watershed clips may only be broadcast after a specified time, for example 9.00 p.m., after which it is assumed that young people will not be watching or will be watching supervised.

If a clip, allowing for the pre-, post-watershed distinction, is ready for broadcast, it is placed into a rotating library at the server 2 and is displayed as part of a TV programme 4 which is broadcast by any TV transmission route, such as analogue TV, digital TV (via aerial, satellite, cable, etc), TV transmitted to mobile terminals such mobile telephones and other TV transmission protocols and methods. In the preferred display technique, the transmitted TV display 4 includes a plurality of windows 5. In a preferred version as shown in FIG. 1 there are nine such windows but any number may be provided.

The display also most preferably includes, in other parts of the screen display, other data such as text 6 imploring a viewer to vote for preferred content, via a telephone number 7 which is required to send his votes to by SMS text message or otherwise. Many other pieces of data may be applied simultaneously and these may include rolling tickers which users may transmit text messages to for immediate display (preferably after a moderation process) and the display in other parts of the screen, of TV channel producer's generated video content and/or audio content to be transmitted. The audio content may be audio generated by the generator of the TV signal or user submitted audio content, in MP3, WMA, WAV, AAC or other formats.

Suitable display processing software places a moderated video clip, either immediately or after it has been in a queue or perhaps according to a scheduled time, in a topmost one 5a, 5b or 5c of windows 5. The first three windows 5a, 5b, 5c are populated by different user submitted video clips for a predetermined period, typically 30 seconds. If the video clip is shorter than 30 seconds, then it may be cycled and repeated during this period. After this predetermined period, each video clip is then moved from the topmost one 5a, 5b or 5c to the next window down, respectively 5d, 5e or 5f and is then again played for 30 seconds. Further videos are then played in the previously vacated topmost windows 5a to 5c. After a further predetermined period (usually the same as that for the first, i.e. typically 30 seconds), the video clips are then moved down one place in the column from 5d to 5g, 5e to 5h and 5f to 5i, and the upper windows refreshed with further clips.

When displayed in any of the windows 5, the video clip has appended to it the unique reference ID or PIN which was previously associated with it. This is therefore displayed as part of the clip. Viewers can then vote for the clip by any convenient voting mechanism, such as by sending SMS voting messages to a predetermined telephone number, in this case the number is 63263. Thus, the original submitter 1 may vote from his mobile phone for his own clip, or any other person, either associated with or totally independent of the original submitter 1, but who appreciates the clip and wants to vote for it, can vote 8. In a preferred embodiment, votes are cast using SMS text messaging via a voting means 9 which can use SMS charging to charge each voter.

After each clip has been in each of the 3 (or more) windows in a column, it drops off the column. However, any person who has noted the unique reference number associated with that clip can still vote at any time after the video has dropped off.

Referring to FIG. 2, the initial display 4a includes nine windows, each including a video clip, the clips being gradually moved down the columns and new clips coming to replace them. Once a video clip receives a predetermined number of votes (for example six votes), then that clip can then be played out in a full screen (or at least larger screen mode shown as 4b). This therefore represents an incentive either for the original submitter to vote several times for his own content to be shown in full screen, or for others to show their appreciation. In the full screen mode, typically only one main video is shown 4b and this may be shown for a predetermined period such as 30 seconds or longer. Once the showing is over, then the screen display reverts to multi-window format 4 and more clips are displayed in the small windows.

In effect, when a clip receives the predetermined number (six) of votes, then that content is brought to the front of the library storing all the current clips and is then played out full screen. If a submitter therefore wants to have his content displayed at full screen at around a certain time on a certain day, he might then make sure that he votes for his content just before that time, or asks his friends and colleagues to do so. One use might therefore be for a user to try to get his video content displayed at a certain time and date.

There may be many other possibilities, for example when a clip or other video or audio content is playing out full screen, viewers might have the ability to vote off that clip. This is, instead of using a predetermined number of votes to play the clip, when the clip is playing if it receives a certain number of “anti” votes, the clip may then be removed prematurely and the display reverts back to multi-window mode or displays another clip in full screen.

The full screen clips may be played at regular intervals, say one every 10 minutes, 15 minutes, 30 minutes, 1 hour or any other time period, or may be displayed automatically once the clip receives, say, six votes.

Various game scenarios can be included in which people must vote according to various rules regarding content of the video clip in order to win prizes. Viewers may also interact with the TV display using text to screen messaging.

1. A TV content transmission and broadcasting system comprising means for transmitting video content to a server; means for reviewing the content; means for allocating a unique identifier to the content; means for broadcasting the content via a TV channel; and means enabling votes to be cast for that content whereby subsequent transmission of the content is determined by rules associated with votes cast.

2. A system as claimed in claim 1, wherein the means for enabling submission of content includes a charging mechanism.

3. A systems as claimed in claim 1 or claim 2, wherein the means for enabling voting includes a charging mechanism.

4. A system as claimed in claim 1, including a moderating means.

5. A system as claimed in claim 1, wherein the content is at least initially displayed in one of a plurality of windows of a display.

6. A system as claimed in claim 5, wherein after a predetermined number of votes has been cast for that content, the content is subsequently displayed in a larger window or full screen.

7. A system as claimed in claim 1, wherein the content is provided with a unique reference identifier.

8. A system as claimed in claim 1, wherein the content is displayed full screen or in a smaller window on a display for a predetermined amount of time.

9. A system as claimed in claim 8, wherein the content is displayed in one of a plurality of windows on a display for a predetermined amount of time then moved through selected ones of an array of windows, whereby after a piece of content vacates a window, further content is displayed in that window, thereby enabling a continuous display of a plurality of independent pieces of content in each of the windows, the content changing with time.

10. A system as claimed in claim 1, wherein the content is video generated by, or transmitted from, a mobile terminal such as a mobile telephone.

11. A method of describing user generated audiovisual content, comprising transmitting the content to a server; reviewing the content; allocating a unique identifier to the content; broadcasting the content via a TV channel and enabling votes to be cast for that content whereby subsequent transmission of the content is determined by rules associated with votes cast.

12. A method as claimed in claim 11, wherein a charging mechanism is used during the submission of content and during voting.

13. A method as claimed in claim 12, wherein the content is initially displayed in one of an array of windows on a display.

14. A method as claimed in claim 13, wherein if a predetermined number of votes is cast for that content, the content is subsequently displayed in a larger window or full screen.

15. A method as claimed in claim 11, wherein the content is initially displayed in one of an array of windows on a display for a predetermined amount of time and is then moved through a predetermined number of windows in the array, each for a predetermined amount of time, each window, after being vacated by a piece of content, being refreshed with a further piece of content from the same or a different provider.
